(19) United States
(12) Patent Application Publication
(10) Pub. No.: US 2006/0155653 A1
(43) Pub. Date: Jul. 13, 2006

(54) Gms sms based authentication system for digital tv

(75) Inventors: Tord Persokrud, OSLO (NO); Ole Hansvold, Nittedal (NO)

Correspondence Address: Ronald R Santucci;Frommer Lawrence & Haug, 745 Fifth Avenue, New York, NY, 10151, US

(73) Assignee: CONAX AS, OSLO (NO)

(21) Appl. No.: 10/535,978

(22) PCT Filed: Nov. 25, 2002
(86) PCT No.: PCT/NO02/00438

§ 371 Date: Jan. 5, 2006

(51) Int. Cl. G06Q 99/00

(52) U.S. Cl. 705/67

(57) ABSTRACT

A dynamic authentication system for digital TV, the system comprising a mobile telephone to be operated by an end-user in connection with a digital TV receiver, the mobile phone being adapted for the short message systems SMS, a tamper resistant module, such as a user smart card in the digital TV receiver being adapted to generate a dynamic authentication code to be shown on the television screen (TV), the end-user reads and enters said authentication code into his mobile phone, said authentication code and application specific data thereafter being sent via SMS to an application server containing or making use of an authentication code validation system, and depending on whether among others the authentication code is acceptable, grants or conducts a certain service for the end-user.

The present invention relates to a dynamic authentication system for digital TV.

Most broadcast networks today are one-way meaning that they are designed to carry broadcast signals from the content provider to the end-user, but not to carry information from the end-user and back to the content provider or distribution operator. Exceptions include some broadband networks and two-way cable networks,

In order to facilitate two-way interactive television (iTV), the end-user needs to send requests or responses through a second network herein denoted the return path network.

Some types of iTV applications require the user to accept terms or confirm actions. Examples are TV-shopping where the user orders and pays electronically for delivery of physical or electronic goods, and money games where the user places a bet-combination and pays electronically. In such scenario, the digital TV operator needs an authentication mechanism to ensure the identity of the user and for collection of a conscious approval from the user of the action to be made. The identity may be required e.g. due to legislation (not allowed to bet unless over 18 years old) and the user approval is required e.g. for withdrawal of money directly from the user's bank account.

The aforementioned conditions are met by the authentication system according to the present invention, as defined by the features stated in the claims.

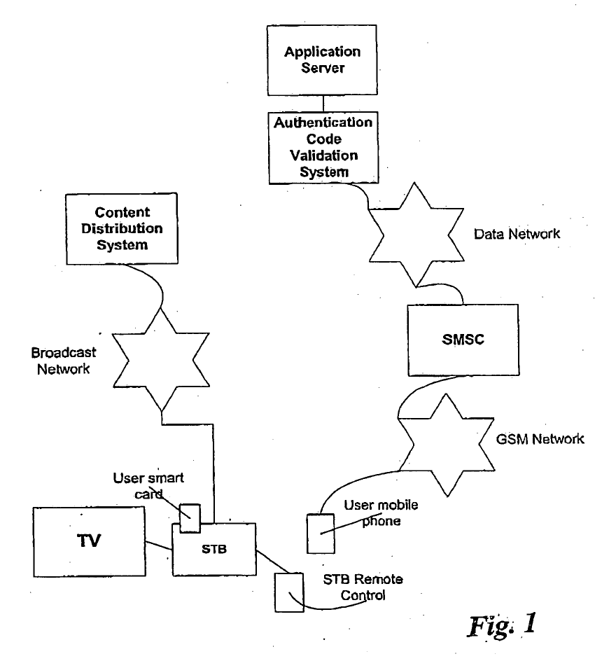

FIG. 1 discloses a typical digital TV scenario according to the present invention, and

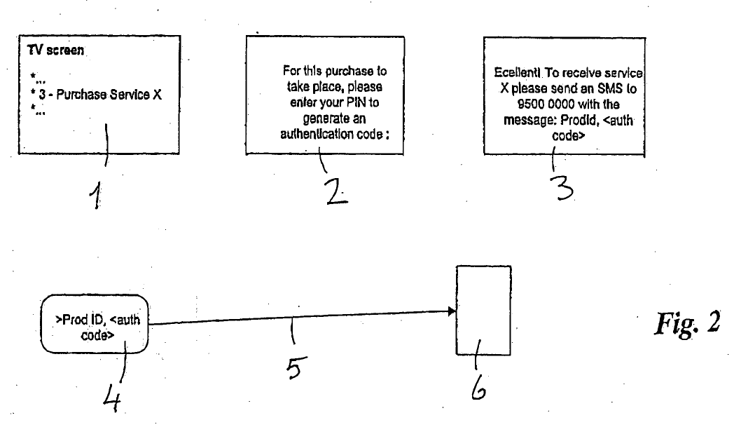

FIG. 2 discloses with a block diagram the operational sequences of the authentication system according to the present invention.

This invention defines a way of using a digital TV receiver, which could be a digital TV set top box, a PC able to receive digital TV signals or a TV with embedded digital TV reception capability, in conjunction with a return path network to achieve authentication, the return path network can be of several types, one being a GSM network and in particular the short message system (SMS).

SMS allows the end-user to input some messages/text, e.g. the response to a quiz, allows the user to be anywhere when generating the request or response, and allows the request/response to be handled fully electronically with the content provider or distribution operator. For faster penetration, ability to address all GSM users with the same concept, general handling in the system operations and to be as autonomous as possible versus a particular GSM operator e.g. with respect to not having to share revenue, it is desirable for the iTV operator to have an authentication mechanism that is GSM operator independent. In practice, this implies that the authentication data must be entered into the SMS message by the end-user.

The SMS messages will be secured by the mechanisms built into the GSM network, and thereby a reasonable confidentiality level is obtained towards monitoring of the GSM network activity. However, the SMS message is not protected versus the GSM operator himself, and the SMS message is not protected when in gateways between the GSM network and the network contributing the SMS message to the iTV operator.

A static authentication mechanism, such as a PIN code, can therefore easily be compromised or the end-user can deny having performed an action. The authentication mechanism should therefore be dynamic, i.e. the authentication data must be different per transaction. Decent dynamic authentication cannot be based on end-users remembering of codes, rather, it needs to be based on an electronic security device in the possession of the user.

In FIG. 1, the user has access to a mobile phone that can utilise SMS. In digital TV it is common that the user digital TV receiver supports encrypted (or scrambled) services—pay-TV services, and is equipped, with a tamper resistant module, usually a smart card (User smart card), comprising an environment where secret information such as cryptographic keys and codes are stored and used in order to decide if access shall be granted to an encrypted TV service.

In conjunction with iTV, the User smart card in the digital TV receiver can be used as a generator of dynamic authentication codes. FIG. 2 shows the general mechanism where the user, when requiring a new code to authenticate a message to be sent to the operator via SMS, first enters into a dialogue with the digital TV receiver and user smart card to generate an authentication code. As a part of this dialogue, the end-user should be requested to present a secret to open for dynamic authentication code generation. This secret could be a normal static PIN code. The secret is checked by the User smart card, and, if accepted, the User smart card generates a new dynamic (or one-time) authentication code. The cryptographic algorithm and keys used by the User smart card to generate the dynamic authentication code must be characterized by very low probability of one being able to predict the next authentication code based on correlation of some or all of the previous authentication codes. The authentication code generated by the User smart card is displayed on the TV screen by the digital TV receiver. The end-user reads the authentication code and enters it into the request or response message, possibly together with other data to identify the service and the user, to be sent to the operator via SMS. The SMS message is then sent to the operator.

The operator has an authentication code validation system that contains the same or complementary cryptographic algorithms and keys making the authentication code validation system able to verify the authentication code in the message from the user.

The authentication code validation system resides in—or is associated with—a service application server, and depending on whether among others the authentication code validation system deems the authentication code from the user acceptable, the service application server grants or conducts a certain service for the end-user.

FIG. 2 discloses the general activity procedure by the following main steps:

1. The user interacts with the digital TV receiver, via the digital TV receiver remote control, and decides to purchase service X

2. The user enters a PIN to open for the User smart card to generate a new dynamic authentication code.

3. The User smart card has generated an authentication code that is being shown on the TV.

4. The user enters the authentication code in an SMS message on his mobile telephone.

5. The SMS message is sent to the operator and the authentication code to the authentication validation system for validation.

6. Upon positive validation, the service application server grants service or not, and potentially send an SMS “receipt” back to the user.

The authentication code is made variable by involving a changing parameter, e.g. an always increasing sequence number that has a different value each time an authentication code is generated.

The authentication code can be independent of the other transaction data, or (selected) transaction data can form a part of the basis for calculation of the authentication code. Examples of transaction data for the latter case are a product reference, a payment sum, an account number, an identity number, etc.

The SMS message may contain a reference to—and/or a parameter related to the service offering the user wants to respond to. The SMS message may contain a user reference, e.g. the User smart card number.

The invention is not restricted to the above-described embodiment but can be varied in a number of ways within the scope of the invention.

1. A dynamic authentication system for digital TV, wherein the system comprising a mobile telephone to be operated by an end-user in connection with a digital TV receiver, the mobile phone being adapted for the short message system SMS, a tamper resistant module, such as a user smart card, in the digital TV receiver being adapted to generate a dynamic authentication code to be shown on the television screen (TV), the end-user reads and enters said authentication code into his mobile phone, said authentication code and application specific data thereafter being sent via SMS to an application server containing or making use of an authentication code validation system, and depending on whether among others the authentication code validation system, and depending on whether among others the authentication code is acceptable, grants or conducts a certain service for the end-user.

2. A dynamic authentication system according to claim 1, wherein the authentication code being generated by the User smart card in the digital TV receiver and passed to the mobile phone, together with some application specific data, through some data channel, such as Bluetooth, IR, wireless USB, FireWire, USB, LAN, WLAN, connecting the digital TV receiver and the mobile phone.

3. A dynamic authentication system according to claim 1, wherein a GSM modem being embedded in the digital TV receiver.

4. A dynamic authentication system according to claim 1, wherein the return path network is any other data channel.

5. A dynamic authentication system according to claim 1, wherein the user digital TV receiver being a digital TV set top box, or a PC able to receive digital TV, or a TV-set with integrated digital TV capability.

6. A dynamic authentication system according to claim 1, wherein the digital TV receiver, rather than the User smart card, generating the dynamic authentication code.
